(19) United States
(12) Patent Application Publication
(10) Pub. No.: US 2016/0140328 A1
(43) Pub. Date: May 19, 2016

(54) APPLICATION OF DIGITAL RIGHTS MANAGEMENT TO EMAILS BASED ON USER-SELECTED EMAIL PROPERTY SETTINGS

(71) Applicant: KONICA MINOLTA LABORATORY U.S.A., INC., San Mateo, CA (US)

(72) Inventors: Rabindra Pathak, San Jose, CA (US); Kyohei Shiraishi, San Mateo, CA (US)

(73) Assignee: KONICA MINOLTA LABORATORY U.S.A., INC., San Mateo, CA (US)

(21) Appl. No.: 14/547,053

(22) Filed: Nov. 18, 2014

(51) Int. Cl. G06F 21/10; H04L 29/06

(52) U.S. Cl. CPC G06F 21/10; H04L 63/20

(57) ABSTRACT

A method for automatically applying digital rights management (DRM) to outgoing emails based on a color category of the email set by the sending user. A plugin module on the user's computer interacts with the email application to extract the color category setting for the email and converts it to a category ID recognized by the digital rights management (RMS) server. The RMS server determines the DRM policy corresponding to the category ID using an association table, and applies that DRM policy to protect the email before sending the email to an exchange server. When a recipient receives the email, the application program on the recipient's computer cooperates with the RMS server to determine whether the recipient is allowed to access the email based on the DRM policy that has been applied to the email.

### BACKGROUND OF THE INVENTION

1. Field of the Invention

This invention relates to digital rights management for emails (electronic mails), and in particular, it relates to a method for automatically applying digital rights management policies to emails based on user-selected email property settings such as color category.

2. Description of Related Art

With the wide use of digital documents and digital document processing, digital rights management systems (“DRM” or “RMS”) are increasingly implemented to control user access to and prevent unauthorized use of digital documents. The rights involved in using a digital document may include the right to view (or “read”), edit (or “write”), print, or copy the digital document, the right to transmit the document by email, etc. A user may access a digital document by acquiring or being assigned one or more of these rights. DRM systems are generally implemented for managing users' rights to the digital documents managed by the systems. DRM systems can be used to protect various types of documents, such as .PDF (Portable Document Format), .DOC (Microsoft™ Word™), .XSL (Microsoft™ Excel™), .MSG (Microsoft™ Outlook™) files, etc.

In a current DRM system, each digital document is associated with a digital rights management policy that specifies which user has what rights to the document, as well as other parameters relating to access rights. Many such policies are stored in an RMS server (also called DRM server). The server stores a database table that associates each document (e.g. by a unique ID, referred to as document ID or license ID) with a policy (e.g. by a policy ID). Each digital document may also have metadata that contains the document ID. When a user attempts to access a document using an application program such as Adobe™ Reader, the application program contacts the RMS server to request access permission. The server determines whether the requesting user has the right to access the document in the attempted manner (view, edit, print, etc.), by determining the policy associated with the document and then referring to the content of that policy. The server then transmits an appropriate reply to the application program to grant or deny the access. If access is granted, the server's reply may contain a decryption key to decrypt the document.

Separately, color category (or color label) is a feature provided in some email applications such as Microsoft™ Outlook™ and Mozilla™ Thunderbird™ to categorize email items for desired purposes. Outlook™ is used as an example in the descriptions below. The user is allowed to set a color category for each email item, or leave it unspecified. The email application can be configured to display the color category of email items for easy visual identification, e.g. by displaying a colored symbol associated with the email items, to group or sort email items in mailboxes according to their color categories, etc. The user is also allowed to assign labels to the color categories for his convenience. It should be noted that the color category features in conventional email applications is completely separate from and independent of DRM technologies.

### SUMMARY

Embodiments of the present invention provide enhancement of the color category feature of email applications using a digital rights management system. Once the user sets a color category for an outgoing email item, DRM policies can be automatically applied to the email item, including both the email message and the attachments, to protect the email from unauthorized access.

An object of the present invention is to make it easy for the user to apply digital rights management policies to emails and email attachments when sending emails by utilizing the color category feature of the email application.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a digital rights management method implemented in a system including a client computer and a digital rights management server (RMS server) for protecting electronic mails (emails), which includes: by the client computer: (a) receiving data representing an email; (b) retrieving a category setting parameter associated with the email, the category setting parameter having been specified by a user; (c) converting the category setting parameter into a category ID, by looking up a category mapping table stored on the client computer which maps a plurality of category setting parameters to a plurality of category IDs; and (d) transmitting the data representing the email along with the category ID to the RMS server; and by the RMS server: (e) determining a digital rights management policy ID corresponding to the category ID received from the client computer, by looking up a category ID mapping table stored on the RMS server which maps a plurality of category IDs to a plurality of policy IDs; (f) applying digital rights management protection to the data representing the email based on a digital rights management policy corresponding to the policy ID, to generate a protected email document; and (g) transmitting the protected email document to an email exchange server.

In another aspect, the present invention provides a digital rights management method implemented in a system including a client computer and a digital rights management server (RMS server) for protecting electronic mails (emails), which includes: by the client computer: (a) receiving data representing an email; (b) retrieving a category setting parameter associated with the email, the category setting parameter having been specified by a user; (c) converting the category setting parameter into a category ID, by looking up a category mapping table stored on the client computer which maps a plurality of category setting parameters to a plurality of category IDs; and (d) transmitting the category ID to the RMS server; and by the RMS server: (e) determining a digital rights management policy ID corresponding to the category ID received from the client computer, by looking up a category ID mapping table stored on the RMS server which maps a plurality of category IDs to a plurality of policy IDs; (f) generating a unique document ID and an encryption key; (g) storing the document ID in association with the digital rights management policy ID and the encryption key in a protected document database; and (h) transmitting the unique document ID and the encryption key to the client; by the client computer: (i) encrypting the data representing the email using the encryption key to generate an encrypted document, and embedding metadata including the document ID in the encrypted document to generate a protected email document; and (j) transmitting the protected email document to an email exchange server.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a data processing system which implements embodiments of the present invention.

FIG. 2 schematically illustrates a DRM protection method for emails according to an embodiment of the present invention.

FIGS. 3A, 3B and 3C illustrate exemplary color category mapping table, category ID mapping table, and DRM policy database, respectively, that may be used to implement embodiments of the present invention.

FIG. 4 schematically illustrates a DRM protection method for emails according to another embodiment of the present invention.

### DETAILED DESCRIPTION OF PREFERRED EMBODIMENTS

The description herein of the structures, functions, interfaces and other relevant features, such as digital rights policies, application programming interface (API) for rights management and policies, etc., of existing DRM systems may at times incorporates, references or otherwise uses certain information, documents and materials from publicly and readily available and accessible public information, e.g., “Rights Management” (URL http://help.adobe.com/en_US/livecycle/10.0/Overview/WS92d06802c76abadb2c8525912ddcb9aad9-7ff8.html), “Programmatically applying policies (a subsection of ‘Rights Management’)”, (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc. Another example of digital rights management system is Microsoft Active Directory Rights Management; some documentations for this system are available on line at: http://technet.microsoft.com/en-us/windowsserver/dd448611.aspx, http://msdn.microsoft.com/library/cc530389(VS.85).aspx, and http://msdn.microsoft.com/em-us/library/cc542552(v=vs.85).aspx.

Color category is a useful feature provided by some email applications, such as Microsoft™ Outlook™, for visualizing and grouping email items. Some email applications also provide other categorizations of email items, such as categorization according to importance, sensitivity, security settings, etc. in the case of Outlook™. Embodiments of the present invention provide a digital rights management method that utilizes the color categories or other categorization features provided by email applications to conveniently apply DRM protection to email items and their attachments. The descriptions below use color categories as an example.

According to embodiments of the present invention, once a user of an email application sets a color category for an outgoing email, DRM protection will be automatically applied to the email without the user performing any other action to request DRM protection. The level of DRM protection applied to the email corresponds to the color category set by the user. For example, red, green and yellow color categories can respectively correspond to high, medium and low levels or protection.

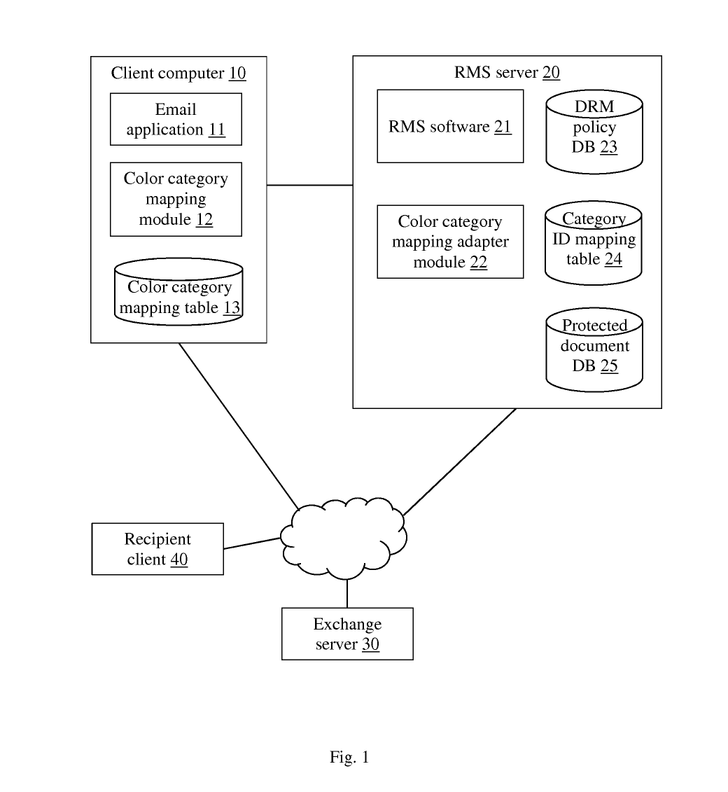

FIG. 1 schematically illustrates a computer system which implements embodiments of the present invention. Each of the client 10, RMS server 20 and exchange server 30 is a computer having necessary hardware such as processor(s), memory(s), etc. (not shown in the drawings) and loaded with software application executed by the processor(s). Each application or software module of the computers includes software which can be executed by processor(s) to perform specified functions. The client 10, RMS server 20 and the exchange server 30 may be connected to each other via one or more networks such as the Internet or an intranet or other networks. The RMS server 20 and the exchange server 30 may be the same server.

As shown in FIG. 1, the client computer 10 includes an email application program 11, which may be, for example, a known email application such as Microsoft™ Outlook™, Lotus™ Notes™, or any other suitable email application. The email application 11 provides a function that allows the user to set a color category for individual email items. The client 10 further includes a color category mapping program module (a plugin) 12, which interacts with the email application 11, and a color category mapping table 13. The color category mapping module 12 works as a client to communicate with the RMS server 20. The RMS server 20 includes core RMS software 21 that performs various digital right management functions, and a color category mapping adapter program module 22 that interacts with the RMS software 21. The RMS server 20 further includes a DRM policy database 23, a protected document database 25, and a category ID mapping table 24. Embodiments of the present invention can be implemented by providing the color category mapping module 12 and the color category mapping table 13 in the client 10, without requiring any modification of the email application 11; and providing the color category mapping adapter module 22 and the category ID mapping table 24 in the RMS server 20, without requiring any modification of the RMS software 21 and DRM policy database 23 which may be provided by a conventional DRM system. The functions of the various components of the client 10 and RMS server 20 are described in more detail below. The exchange server 30, which is connected to an external network such as the Internet, performs known functions related to transmission of emails.

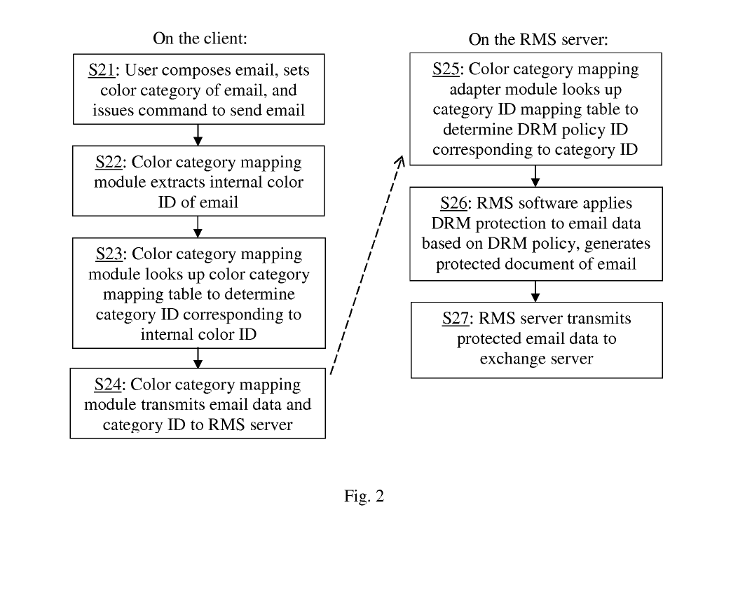

A DRM method according to an embodiment of the present invention is described with reference to FIG. 2. As a preliminary step (not shown in FIG. 2), the email application 11 on the client 10 is configured to assign a user-friendly label to each color category. This may be done by the user of the email application, for example by using menu operations provided by the email application 11. Alternatively, to ensure uniformity among users, the color category labels may be set by configuring user account settings for the user of the email application on the exchange server 30 or the RMS server 20, which may be done by an administrative user, and the email application 11 on the client 10 can automatically download the settings from the exchange server. The labels assigned to each color category preferably conveys the level of protection to be applied to the emails, such as “Public (Green)” for the green category, “Internal Use Only (Yellow)” for the yellow category, and “Confidential (Red)” for the red category, etc.

In step S21, the user composes an email, including attaching any desired attachments, sets the color category of the email to a desired color, and issues a command to send the email. The actions of this step, including setting the color category of the email, are performed using user interface features such as menus provided by the email application 11.

The color category mapping module 12 intercepts the communication between the email application 11 and the exchange server 30, so that instead of being transmitted directly to the exchange server 30, the data of the email is processed by the color category mapping module 12 first and then transmitted to the RMS server 20. Thus, in step S22, the color category mapping module 12 receives the email data from the email application 11, and interacts with the email application 11 to retrieve the color ID associated with the email. The color ID is a parameter used internally by the email application 11 to identify the color category of emails. The color category mapping module 12 accesses the internal application data of the email application 11 to retrieve the color ID for the outgoing email.

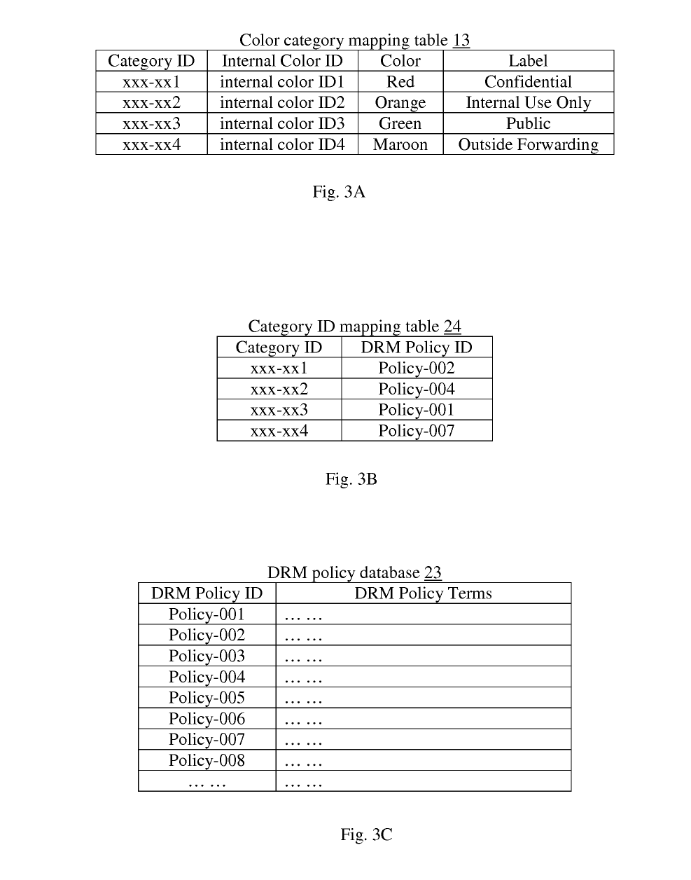

The color category mapping module 12 looks up the color category mapping table 13 to determine a category ID for the email (step S23). The color category mapping table 13, an example of which is shown in FIG. 3A, associates the internal color IDs used by the email application 11 with category IDs used by the DRM system. Because different email applications on different clients may use different internal color IDs for the color categories, the color category mapping table 13 is specific to the email application 11 so that the color category mapping module 12 can convert the internal color IDs to the category IDs that will be recognized by the RMS server 20. It should be noted that the colors (red, etc.) and labels (“confidential”, etc.) are also internal to the email application 11, e.g., the email application uses these when displaying the email items in mailboxes (as mentioned earlier, the email application has been configured to use these definitions); these two columns are shown in FIG. 3A for illustrative purpose only, and the color category mapping table 13 does not need to contain these two columns.

The color category mapping module 12 then transmits the email data and the category ID to the RMS server 20 (step S24). After the RMS server 20 receives the email data along with the category ID, the color category mapping adapter module 22 looks up the category ID mapping table 24 to determine the DRM policy ID that corresponds to the category ID (step S25). The category ID mapping table 24, an example of which is shown in FIG. 3B, associates the category IDs with DRM policy IDs. The association is preferably a one-to-one mapping. Thereafter, based on the DRM policy determined in step S25, the RMS software 21 applies appropriate DRM protection to the email data (step S26). The specific actions of this step depend on the protection mechanism used by the DRM system. For example, in one embodiment, the RMS software 21 encrypts the email data to generate one or more encrypted documents (for example, each attachment may be encrypted into a separate document, or the message and the attachments may be encrypted into one encrypted file), assigns a unique document ID to each document, embeds the document ID and other metadata in each document, and stores each document ID along with the associated DRM policy ID and encryption key in a protected document database 25 on the RMS server 20. In step S26, the RMS software 21 may need to consult the terms of the DRM policy to be applied to the email. The DRM policy database 23 (see FIG. 3C) stores terms of each DRM policy, which may include, for example, the various digital access rights (e.g., read, print, edit, external forward, internal forward, etc.) granted or denied to various users of the DRM system, effective time periods of the policy, etc. In step S26, the message part of the email and the attachments of the email may be processed together or separately.

Note that in addition to the category ID mapping table 24, the RMS server 20 may also contain an association table that associates the category IDs with the colors (e.g. Red) and labels (e.g. “Confidential”), so that this association can be downloaded to the client 10 when configuring the email application.

After digital rights protection has been applied, the RMS server 20 transmits the email data (encrypted) to the exchange server 30 (step S27). The RMS server 20 may include an SMTP client to perform this function. The exchange server 30 handles the email according to conventional technology to transmit the email to its recipients 40.

After the email is received by a recipient 40, the email application or other application (such as a PDF reader application, a word processing application, etc.) on the recipient's computer 40 cooperates with the RMS server 20 according to conventional technology to enforce access control of the email. For example, in some DRM systems, the email application of the recipient 40 extracts the document ID from the encrypted document, and transmits an access request, containing the document ID along with a user ID of the recipient and other relevant data, to the RMS server 20. The RMS server 20 determines the DRM policy ID associated with the document ID by referring to the protected document database 25, and determines the rights to be granted to the recipient user under the DRM policy by referring to the policy terms stored in the DRM policy database 23. The RMS server 20 then transmits an appropriate reply to the recipient 40 to grant or deny the access. If access is granted, the server's reply may contain a decryption key for the recipient 40 to decrypt the document. Attachments to the email can be processed in similar ways by appropriate applications such as Adobe™ Reader, etc.

In practical use, the IT management team of an organization can set guidelines for users regarding sending sensitive information via email. The guidelines may require the users to specify a color category to identify the characteristics of the email. The DRM method according to the above embodiment can then automatically apply DRM protection to emails without requiring the user to perform any other action beyond setting the color category for the outgoing email. Certain DRM policies, such as “Internal Use Only,” are particularly useful for controlling access to emails. In this example, the DRM policy corresponding to a color category representing “Internal Use Only” will deny access to any users who have different domains than the sender. Thus, even if the email is sent to an external recipient by accident, external users will not be allowed to open the email and attachments.

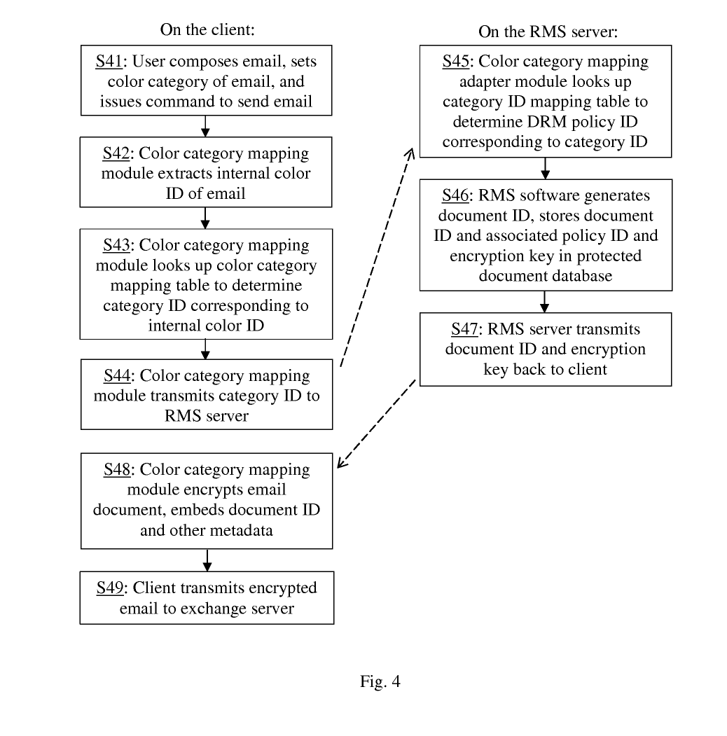

In an alternative embodiment, shown in FIG. 4, the step of applying DRM protection to the email is partly performed by the color category mapping module 12 of the client 10. In the alternative method shown in FIG. 4, steps S41, S42, S43 and S45 are identical to steps S21, S22, S23 and S25 of FIG. 2. In step S44, the color category mapping module 12 only transmits the category ID to the RMS server 20, without transmitting the email data. After the color category mapping adapter module 22 of the RMS server 20 determines the DRM policy ID corresponding to the category ID (step S45), the RMS software 21 generates one or more document IDs (e.g. for the message and the attachments separately) and encryption keys, and stores each document ID along with the associated DRM policy ID and encryption key in the protected document database 25 (step S46). The RMS server 20 transmits the document IDs and encryption keys back to the client 10 (step S47). The color category mapping module 12 of the client 10 encrypts the email data including the attachments using the encryption keys, and embed the document IDs in the encrypted documents (step S48). The email message and attachments may be encrypted as one document or separately encrypted. The client 10 then transmits the encrypted email documents to the exchange server 30 (step S49). In this alternative method, the RMS server 20 does not process the actual email data.

In addition to outgoing emails, the above method may also be used to apply DRM protection to email items stored in a user's mailbox. The user sets a color category for an email item, and the color category mapping module 12 cooperates with the RMS server 20 to apply DRM protection to the email items according to the color category. Steps S42 to S48 described above (see FIG. 4) may be used to accomplish such protection, although the protected email will not be transmitted to the exchange server 30. This is useful as when this email item is later forwarded to other users, it will have already been applied with DRM protection.

In Microsoft™ Outlook™, the color category information is normally not transmitted along with the email data to the exchange server. The color category mapping module 12 intercepts the email data and extracts the color category information from the email application 11. For some other categorization parameters, such as importance, sensitivity, security, etc., the parameters are normally a part of the email data that would be transmitted to the exchange server. Thus, the email application 11 can extract the internal IDs directly from the email data.

As mentioned earlier, embodiments of the present invention can be implemented by providing the color category mapping module 12 and the color category mapping table 13 in the client 10, without requiring any modification of the email application 11; and providing the color category mapping adapter module 22 and the category ID mapping table 24 in the RMS server 20, without requiring any modification of the RMS software 21 and DRM policy database 23. Alternatively, the functions of the color category mapping module 12 may be integrated into the email application 11, and the functions of the color category mapping adapter module 22 may be integrated into the RMS software 21.

It will be apparent to those skilled in the art that various modification and variations can be made in the DRM method of the present invention without departing from the spirit or scope of the invention. Thus, it is intended that the present invention cover modifications and variations that come within the scope of the appended claims and their equivalents.

What is claimed is:

1. A digital rights management method implemented in a system including a client computer and a digital rights management server (RMS server) for protecting electronic mails (emails), comprising:
by the client computer:
(a) receiving data representing an email;
(b) retrieving a category setting parameter associated with the email, the category setting parameter having been specified by a user;
(c) converting the category setting parameter into a category ID, by looking up a category mapping table stored on the client computer which maps a plurality of category setting parameters to a plurality of category IDs; and
(d) transmitting the data representing the email along with the category ID to the RMS server; and
by the RMS server:
(e) determining a digital rights management (DRM) policy ID corresponding to the category ID received from the client computer, by looking up a category ID mapping table stored on the RMS server which maps a plurality of category IDs to a plurality of DRM policy IDs;
(f) applying digital rights management protection to the data representing the email based on a DRM policy corresponding to the DRM policy ID, to generate a protected email document; and
(g) transmitting the protected email document to an email exchange server.

2. The method of claim 1, wherein the category setting is a color category setting.

3. The method of claim 1, wherein the category setting is selected from a group consisting of a color category setting, an importance setting, a sensitivity setting, and a security settings.

4. The method of claim 1,
wherein step (a) includes a plugin module on the client computer receiving the data representing the email from an email application on the client computer,
wherein the category setting parameter in step (b) has been specified by the user via the email application, and
wherein steps (b), (c) and (d) are performed by the plugin module.

5. The method of claim 1, wherein steps (e) and (g) are performed by an adapter module of the RMS server, and step (f) is performed by an RMS program of the RMS server.

6. The method of claim 1, wherein step (f) includes:
generating a unique document ID and an encryption key;
encrypting the data representing the email using the encryption key;
embedding metadata including the document ID in the encrypted data to generate the protected email document; and
storing the document ID in association with the DRM policy ID and the encryption key in a protected document database.

7. A digital rights management method implemented in a system including a client computer and a digital rights management server (RMS server) for protecting electronic mails (emails), comprising:
by the client computer:
(a) receiving data representing an email;
(b) retrieving a category setting parameter associated with the email, the category setting parameter having been specified by a user;
(c) converting the category setting parameter into a category ID, by looking up a category mapping table stored on the client computer which maps a plurality of category setting parameters to a plurality of category IDs; and
(d) transmitting the category ID to the RMS server; and
by the RMS server:
(e) determining a digital rights management (DRM) policy ID corresponding to the category ID received from the client computer, by looking up a category ID mapping table stored on the RMS server which maps a plurality of category IDs to a plurality of DRM policy IDs;
(f) generating a unique document ID and an encryption key;
(g) storing the document ID in association with the DRM policy ID and the encryption key in a protected document database; and
(h) transmitting the unique document ID and the encryption key to the client;
by the client computer:
(i) encrypting the data representing the email using the encryption key to generate an encrypted document, and embedding metadata including the document ID in the encrypted document to generate a protected email document; and
(j) transmitting the protected email document to an email exchange server.

8. The method of claim 7, wherein the category setting is a color category setting.

9. The method of claim 7, wherein the category setting is selected from a group consisting of a color category setting, an importance setting, a sensitivity setting, and a security settings.

10. The method of claim 7,
wherein step (a) includes a plugin module on the client computer receiving the data representing the email from an email application on the client computer,
wherein in step (b), the category setting parameter has been specified by the user via the email application, and
wherein steps (c), (d), (i) and (j) are performed by the plugin module.

11. The method of claim 7, wherein steps (e) and (h) are performed by an adapter module of the RMS server, and steps (f) and (g) is performed by an RMS program of the RMS server.

12. A computer program product comprising a first computer usable non-transitory medium having a first computer readable program code embedded therein for controlling a client computer, and a second computer usable non-transitory medium having a second computer readable program code embedded therein for controlling a digital rights management server (RMS server) computer,
wherein the first computer readable program code is configured to cause the client computer to execute a process comprising:
(a) receiving data representing an email;
(b) retrieving a category setting parameter associated with the email, the category setting parameter having been specified by a user;
(c) converting the category setting parameter into a category ID, by looking up a category mapping table stored on the client computer which maps a plurality of category setting parameters to a plurality of category IDs; and
(d) transmitting the data representing the email along with the category ID to the RMS server; and
wherein the second computer readable program code is configured to cause the RMS server to execute a process comprising:
(e) determining a digital rights management (DRM) policy ID corresponding to the category ID received from the client computer, by looking up a category ID mapping table stored on the RMS server which maps a plurality of category IDs to a plurality of DRM policy IDs;
(f) applying digital rights management protection to the data representing the email based on a DRM policy corresponding to the DRM policy ID, to generate a protected email document; and
(g) transmitting the protected email document to an email exchange server.

13. The computer program product of claim 12, wherein the category setting is a color category setting.

14. The computer program product of claim 12, wherein the category setting is selected from a group consisting of a color category setting, an importance setting, a sensitivity setting, and a security settings.

15. The computer program product of claim 12,
wherein the first computer readable program code is a plugin module,
wherein in step (a) the data representing the email is received from an email application on the client computer, and
wherein the category setting parameter in step (b) has been specified by the user via the email application.

16. The computer program product of claim 12, wherein the second computer readable program code includes an adapter module that performs steps (e) and (g), and an RMS program that performs step (f).

17. The computer program product of claim 12, wherein step (f) includes:
generating a unique document ID and an encryption key;
encrypting the data representing the email using the encryption key;
embedding metadata including the document ID in the encrypted data to generate the protected email document; and
storing the document ID in association with the DRM policy ID and the encryption key in a protected document database.
